(19) United States
(12) Patent Application Publication
(10) Pub. No.: US 2008/0193638 A1
(43) Pub. Date: Aug. 14, 2008

(54) Process and Apparatus for Coating Substrates by Spray Pyrolysis

(76) Inventors: Alan J. McMaster, Maumee, OH (US); Dean M. Giolando, Toledo, OH (US); Samia Al-Qaisi, Sylvania, OH (US)

Correspondence Address: FRASER CLEMENS MARTIN & MILLER LLC, 28366 KENSINGTON LANE, PERRYSBURG, OH, 43551, US

(21) Appl. No.: 12/063,939

(22) PCT Filed: Aug. 17, 2006
(86) PCT No.: PCT/US06/32252

§ 371 Date: Feb. 15, 2008

Related U.S. Application Data
(60) Provisional application No. 60/709,211, filed on Aug. 18, 2005.
(60) Provisional application No. 60/728,220, filed on Oct. 19, 2005.

(51) Int. Cl. B05D 5/12; B05B 5/00

(52) U.S. Cl. 427/126.3; 118/621

(57) ABSTRACT

Apparatus and a process for applying a metal oxide coating to a substrate, the process comprising the steps of providing a solution of a metal compound in a solvent, spraying the solution onto the surface of a hot substrate, and pyrolyzing the solution to form a coating of metal oxide on the substrate.

### CROSS-REFERENCE TO RELATED APPLICATION

This application claims the benefit of U.S. Provisional Application Ser. No. 60/709,211 filed Aug. 18, 2005 entitled “COATING SUBSTRATES BY SPRAY PYROLYSIS” and U.S. Provisional Application Ser. No. 60/728,220 filed Oct. 19, 2005 entitled “HOMOGENOUS SPRAY DEPOSITION APPARATUS”.

### BACKGROUND OF THE INVENTION

The present invention relates generally to a process and apparatus for coating substrates by spray pyrolysis. More particularly, the invention is directed to a process and apparatus for spray pyrolysis utilized in applying metal oxides, such as zirconium and titanium oxide, onto substrates of glass, ceramics, plastics, cloth (fabric), and other materials for use in architectural, appliance, and electronic applications, including photovoltaics.

The prior art has disclosed pyrolytic spray processes and apparatus for applying uniform coatings to a surface of a substrate. Typically, the coating to be applied to the substrate is atomized by a delivery system. The delivery system is employed to deliver a uniform flow of liquid to an atomizer adapted to deposit a uniformly thick layer or coating on to a heated substrate. The thermal energy contained within the hot substrate provides energy for the thermal decomposition of the sprayed material and subsequent formation of the coating thereon. Many of the coating liquids are highly electrically conductive, which creates a problem of electrically isolating the atomizer from the liquid delivery system. Without adequate electrical isolation, the resultant electrical paths to ground would adversely effect performance of the coating apparatus and would simultaneously present a safety hazard.

Zirconium oxide coatings resist chemical activity and are able to act as an electrolyte for oxide mobility; an important characteristic for solid oxide fuel cells. Such coatings may also provide high dielectric-constant material for very large scale integrated circuits. Titanium oxide films are photoactive and, when coated on various substrates such as glass, may provide photovoltaic properties and light activated self-cleaning surfaces.

Standard coating apparatus includes a liquid delivery system, wherein the liquid to be delivered is contained within a pressure pot. The contained liquid is typically forced from the pressure pot to an atomizer by compressed air. The compressed air forces the liquid through a tube to an atomizer. Due to variations of the compressed air pressure and back pressure caused by constrictions in the fluid lines, wide variations in fluid flow rates result in unacceptable non-uniform film deposition on the associated substrate.

Attempts have been made to provide a uniform flow rate by utilizing positive displacement pumps.

However, since the pumps are typically powered by AC motors connected to building power sources, the system is not electrically isolated.

It would be desirable to prepare coatings such as zirconium oxide and titanium oxide by improved spray pyrolysis process and apparatus.

### SUMMARY OF THE INVENTION

It surprisingly has been found that the above mentioned problems may be solved by the utilization of a positive displacement pump driven by a DC motor to which electrical energy is supplied by a set of electric storage batteries. Thereby, the liquid delivery system is self-contained and electrically isolated. Since the positive displacement pump is supplied energy from a set of storage batteries, a continuous flow of liquid from the pump can be achieved. Typically, the electrical energy to energize the pump would be provided from one set of batteries, while the second set of batteries is being charged. During charging, the second set of batteries is disconnected from the electrostatic system so as to eliminate a path to electrical ground. It will be understood that the pump may be driven by another prime mover, such as a pneumatic motor, for example.

Also, accordant with the present invention, an improved process for applying a metal oxide coating to a substrate has surprisingly been discovered. The process comprises the steps of providing a solution of a metal compound in a solvent, spraying the solution onto the surface of a hot substrate, and pyrolyzing the solution to form a coating of metal oxide on the substrate.

The present invention also contemplates metal oxide coated substrates produced by the inventive process and apparatus.

The inventive process and apparatus and the products produced thereby are particularly well suited for the production of photovoltaic and optical devices.

### BRIEF DESCRIPTION OF THE DRAWINGS

The objects and advantages of the invention will become readily apparent to those skilled in the art from reading the following detailed description of an embodiment of the invention when considered in the light of the accompanying drawings, in which:

FIG. 1 is a diagrammatic perspective view of the pyrolytic coating apparatus incorporating features of the invention for carrying out the steps of the process and producing the products resulting therefrom;

FIG. 2 is a diagrammatic exploded perspective view of the apparatus illustrated in FIG. 1;

FIG. 3 is a diagrammatic perspective view of the apparatus illustrated in FIG. 1 with the furnace housing being removed to more clearly illustrate the spray chamber zone with a substrate panel entering the spray zone;

FIG. 4 is a diagrammatic illustration similar to

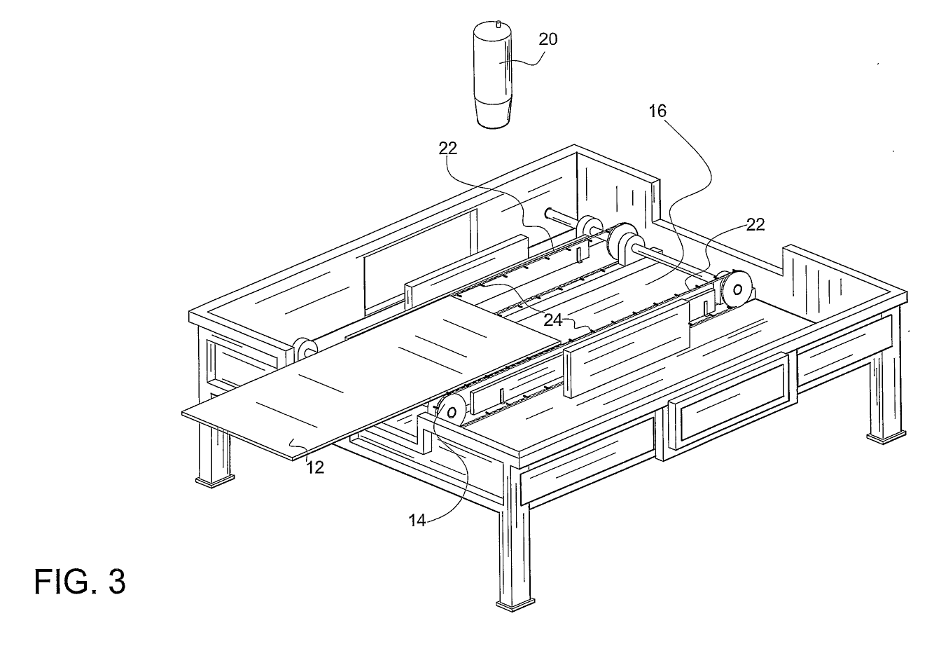

FIG. 3 showing the substrate panel in an intermediate position of travel through the apparatus with a partial coating of film deposited on the upper surface of the transient panel;

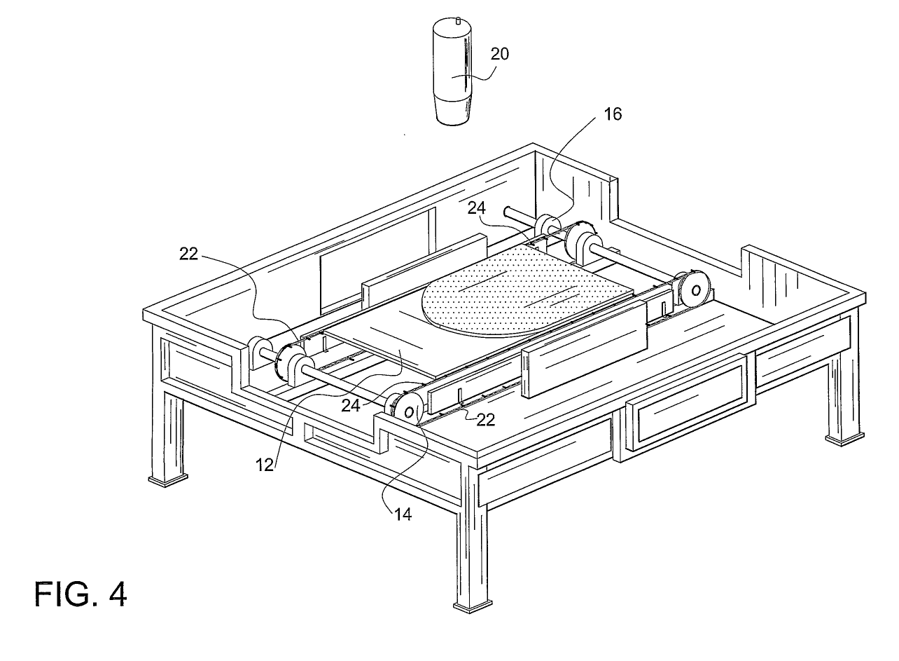

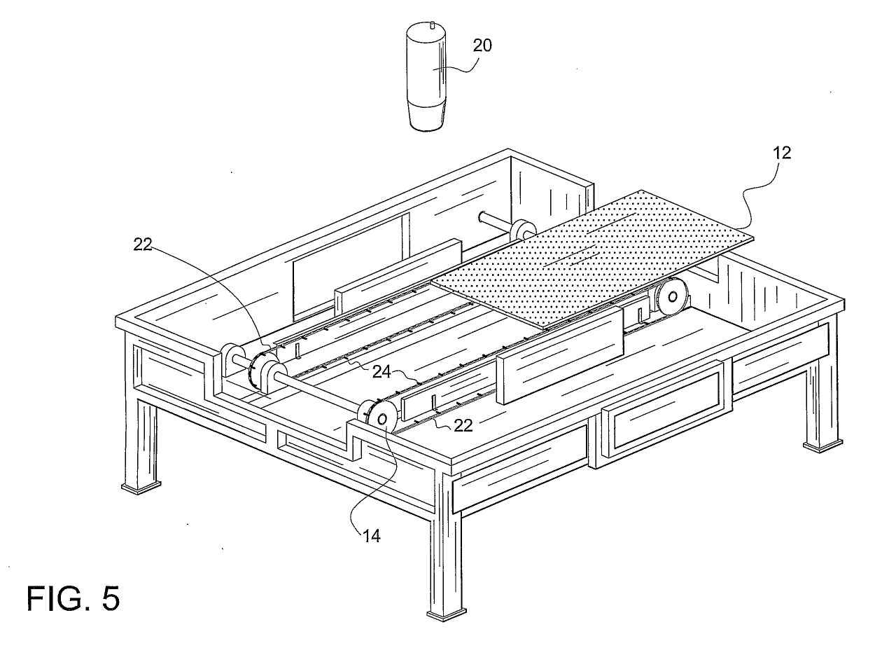

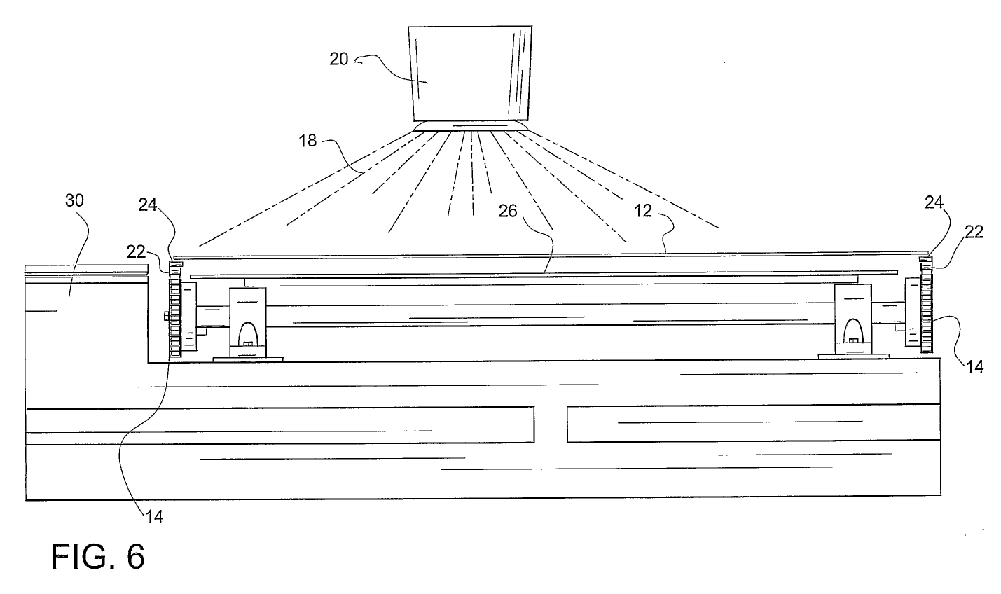

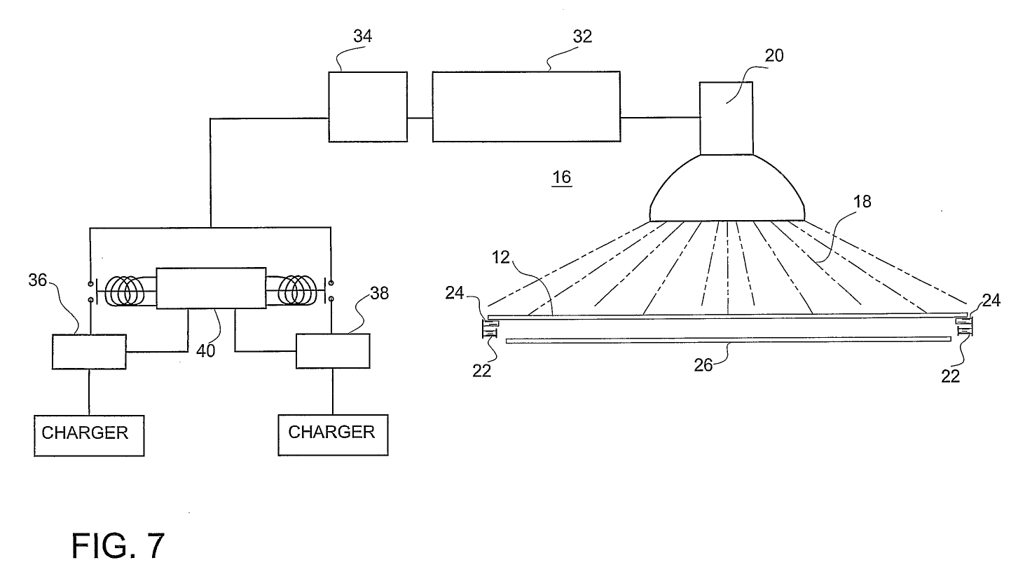

FIG. 5 is a diagrammatic illustration similar to FIGS. 3 and 4 showing the entire upper surface of the transient panel being fully coated and commencing an exit from the apparatus;

FIG. 6 is an enlarged fragmentary end elevational view of the apparatus illustrated in FIGS. 2 through 5 showing the spray pattern of the atomized coating material on the transient substitute panel; and

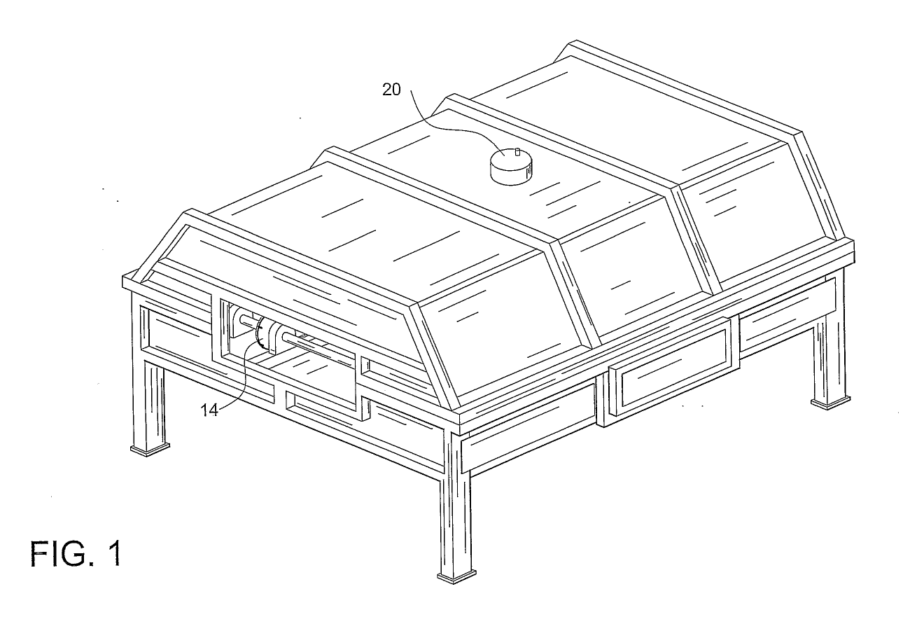

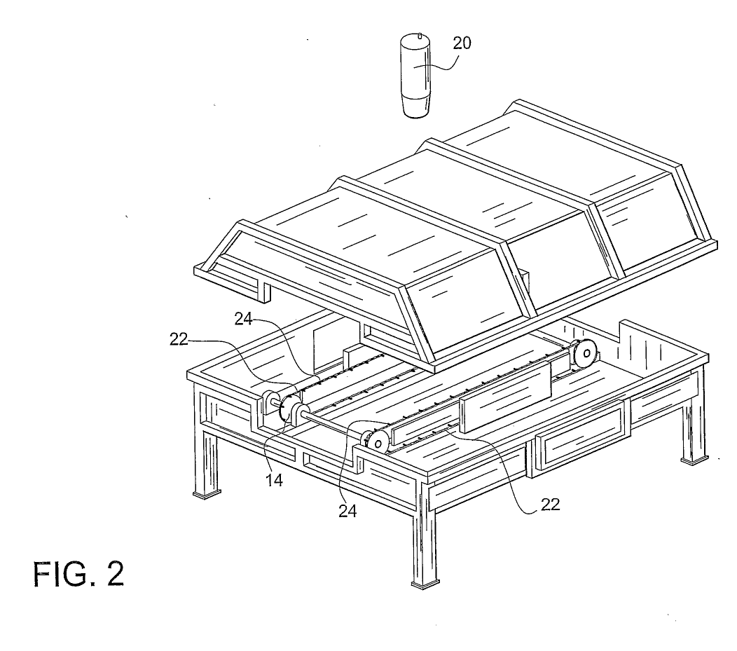

FIG. 7 is a schematic illustration of the pyrolytic coating system incorporating apparatus illustrated in FIGS. 1 through 6 for carrying out the steps of the inventive process for producing the inventive products.

### DETAILED DESCRIPTION OF THE PREFERRED EMBODIMENT OF THE INVENTION

The present invention is directed to an apparatus and process for applying metal oxide coatings to substrates, and to the coated products produced thereby. The apparatus incorporates a liquid spray pyrolysis system for applying film coatings to substrates such as glass, ceramics, plastics, cloth, or other substrate materials for architectural, appliance, and electronic applications including photovoltaics. The process comprises the steps of providing a solution of a metal compound in a solvent, spraying the solution onto the surface of a hot substrate, and pyrolyzing the metal compound to form a coating of metal oxide on the substrate.

An objective of the invention is to provide an improved pyrolytic spray apparatus for depositing a uniform coating on substrates. The system operates at atmospheric pressure and includes a furnace, a spray chamber, an atomizer, and an exhaust/fume scrubber.

The furnace may be of standard roller hearth construction. A substrate 12 to be coated is typically placed on a load conveyor 14 and then transported into the furnace where the substrate 12 is heated to a temperature between 100° C. and 600° C. Upon reaching the desired deposition temperature, the substrate 12 is caused to continue through the furnace and into a spray chamber 16. The chamber 16 is designed to contain the mist 18 generated by an associated atomizer 20 typically mounted in the upper wall of the spray chamber 16. The substrate 12 is transported through the spray chamber 16 by a chain conveyor 22 shown in FIG. 6. The substrate 12 is supported along its lower edge by support pins 24 connected to the chain 22. Clearance is provided to the lower face of the substrate 12, causing the substrate 12 to pass over a ground plate 26 positioned approximately ½″ below the lower face of the substrate 12. The ground plate 26 is approximately the same width as the substrate 12.

The atomizer 20 is centered above the ground plate 26 and the path of travel of the substrate 12 with sufficient height to direct the spray atomized droplets of the mist 18 across the entire width of the substrate 12. The height of the atomizer 20 is typically vertically adjustable. The preferred atomizer is electrostatic; however, any appropriate atomizer could be used. Droplets of the mist 18 leaving the atomizer 20 are negatively charged up to 60 kilovolts. The negatively charged droplets leave the atomizer 20 and are attracted to the ground plate 26. The ground plate 26 is the nearest source of ground to the atomizer 20. The droplets are caused to impinge upon the substrate 12, as the droplets move towards the ground plate 26, forming a coating or film on the upper surface of the substrate 12. The negatively charged droplets tend to repel each other to form uniform density throughout the mist 18. Charging the droplets causes the individual droplets to be divided into even smaller sized droplets facilitating the deposition of a coating of uniform thickness. The electrostatic spray greatly improves the material utilization over conventional pneumatic or hydraulic sprayers. The coated substrate continues to be conveyed out of the spray chamber 16 and onto a conveyor (not shown) where the coated product may be inspected and unloaded. Overspray in the spray chamber 16 is collected in an exhaust duct 30, transported to a fume scrubber, and neutralized. The spray chamber 16 is maintained at a slight negative pressure (up to 1″ H₂O) to prevent the overspray from escaping.

The atomizer 20 is typically supplied with liquid by a liquid delivery system. The liquid delivery system must maintain a uniform fluid flow rate in order to produce a coating of uniform thickness. Many of the sprayed liquids are highly electrically conductive. The presence of an electrically conductive liquid presents the problem of electrically isolating the atomizer 20 and the associated liquid delivery system. Any electrical paths to ground results in a loss of performance efficiency and poses a safety hazard. Standard electrostatic spray systems do not satisfactorily address both of these problems. Standard liquid delivery systems typically use a pressure pot to contain the liquid. Compressed air is fed into the pressure pot forcing the liquid out through a fluid line to an atomizer. Suitable materials can be used to electrically isolate the system. However, variations of compressed air pressure and back pressures due to constrictions in the fluid lines cause wide variations in fluid flow rates and accordingly are not acceptable in producing the desired coating. It has been discovered that positive displacement pumps can provide uniform fluid flow rates regardless of fluctuations in back pressures. However, such pumps are typically powered by AC motors connected to building power supplies. Such arrangements prevent the liquid delivery system from being electrically isolated.

It has been found that a continuous flow of a fluid or liquid to be atomized can be achieved by using a positive displacement pump 32 driven by a DC motor 34, as illustrated in FIG. 7. A uniform flow of liquid to be atomized results in a uniform distribution of the atomized fluid to be deposited on the substrate 12. To continuously provide for the uniform flow of liquid to be atomized results in a uniform distribution of the atomized fluid deposited on the surface of the substrate. To continuously provide for uniform flow, the DC motor 34 is operated or energized by one set 36 of electric storage batteries while a second set 38 of batteries is cause to be charged. The second set 38 of batteries being charged is electrically isolated or disconnected from the electrostatic system so as to eliminate a path to electrical ground.

A sensor 40 is used to measure the discharge state of the sets 36, 38 of the batteries. At some predetermined discharge level, the charged battery is automatically connected to the motor 34 and the discharged battery connected to the charger. The added benefit of using the DC motor/battery combination is that the battery supplies a constant voltage to the motor which in turn causes the pump to deliver a constant flow rate. The liquid delivery system can be controlled manually, by PLC or other suitable controller.

A standard electrostatic spray atomizer 20 is typically provided with a pneumatic valve to control the fluid flow. The valve can be a source of liquid leakage and electrical shorts to ground. The pump 32 functions to control the flow of fluid, thereby eliminating the need for a separate control valve. Pneumatic switches in conjunction with electrical contact provide the necessary electrical isolation for human interface. The typical fluid flow rate is less than 100 mL/min. The surface tension of the liquid forms drops of approximately 1 mL. The drops fall from the end of the feed tube onto the rotating atomizer cup, resulting in a pulsed spray which does not form a uniform coating. The pulsing is eliminated by extending the fluid line to close proximity of the rotating atomizing cup. The liquid leaving the fluid line is in continuous contact with the atomizing cup and is unable to form a drop. Liquid is then atomized at a constant rate and forms a uniform coating or film.

The apparatus described hereinabove is particularly useful for applying metal oxide coatings to substrates by a process comprising the steps of providing a solution of a metal compound in a solvent, spraying the solution onto the surface of a hot substrate, and pyrolyzing the metal compound to form a coating of metal oxide on the substrate.

By the term metal compound as the term is used herein is meant a compound of the type M(OR)₄. The metal “M” may conveniently comprise zirconium or titanium, or other metals from which coatings may be applied to substrates by spray pyrolysis. The organic radical may comprise Me, Et, i-Pr, n-Pr, n-Bu, t-Bu, and the like, as well as blends thereof. Thus, the metal compound may comprise zirconium or titanium tetramethoxide, tetraethoxide, tetraisopropoxide, tetra-n-propoxide, tetra-n-butoxide, tetra-t-butoxide, tetraacetylacetonate, tetranitrate, tetraoxolate, and the like, as well as blends thereof.

The metal compound is dissolved in a solvent. The solvent may comprise an alcohol that is compatible with the metal compound, and/or an acid such as hydrochloric acid, acetic acid, and the like, as well as mixtures thereof. Generally, the solution also contains a quantity of water. Moreover, the solvent may contain additional metal oxide and/or metal halide reagents, to provide enhanced properties to the ultimately produced coating.

Optionally, the solution may also contain solid particles or dissolved dopants, to enhance or modify the properties of the applied metal oxide coatings. Suitable particles and dopants include, but are not necessarily limited to, TiC, carbon black, RuO₂, Pd in carbon, ZnO, Ta₂O₅, MgO, CuO, Bi₂O₃, TeO₂, WO₃, TaC, GeO₂, MoO₃, Sb₂O₃, metal particles, as well as mixtures thereof. A preferred dopant is TiC. Dopants in the form of nitrides, sulfides, and fluorides may also be used.

The solution is thereafter sprayed onto a hot substrate. Suitable substrates include, but are not necessarily limited to, glass, coated glass, silicon single crystal wafers, semiconductor devices, fused quartz, various plastics, cloth, and the like. Preferred substrates comprise glass and coated glass. The substrate is heated to a temperature sufficient to cause pyrolysis of the metal compound upon contact with the hot surface of the substrate. Heating may be accomplished by any conventional means, such as by passing the substrate through a furnace. Conveniently, glass and coated glass substrates emerging from various stages of a float glass production, glass tempering, photovoltaic fabrication, or photovoltaic device lamination line may already be heated to a temperature sufficient to cause pyrolysis of the metal compound; thus, no additional heating would be necessary. Generally, the substrate may be heated to a temperature from about 65 degrees C. to about 550 degrees C. Oxygen contained within the spray solution and/or the metal compound contributes to the oxide coating prepared during the pyrolysis.

The metal compound is pyrolyzed as a result of the solution's contact with the surface of the heated substrate, forming a metal oxide coating. Thus, the latent heat of the substrate causes the decomposition of the metal compound, to form the metal oxide. Substrate coated with the metal oxide or its precursor may subsequently be heated to higher temperatures to effect changes as needed by a given application.

The present invention is useful for the manufacture of chemically resistant coatings for photovoltaic devices, where a film of ZrO₂ or TiO₂ may be applied to substrates that degrade at temperatures in excess of 200 degrees C. to 250 degrees C. The invention allows the formation of the protective coating at temperatures low enough so as not to cause damage to the amorphous silicon, CdTe, copper indium dichalcogenide, or other photovoltaic device. The layer can be used as a moisture barrier over a completed photovoltaic module to protect the backside metal electrode, or as a corrosion resistant coating on the front-side window layer for the photovoltaically driven electrolysis of water and other compounds. Such a layer may be combined with another metal oxide film of a different refractive index, to provide for example an anti-reflective coating.

The metal oxide coatings are hydrophobic and sheen water. As such the invention can be used to produce a water sheening layer on windows.

These metal oxide coatings are very resistant to the migration of ionic chemicals, and as such act as barriers to the flow of ions. A layer of the metal oxide can be placed on glass to provide a barrier to the migration of ions out of the glass and into subsequent films of the device. This can be of value for photovoltaic devices, wherein the metal oxide layer is placed between the glass and the window layer transparent conducting oxide (TCO) electrode. In addition to protecting the TCO against the migration of ions out of the glass, the coating can also protect the semiconductor layers as well, particularly for devices wherein the TCO is pre-scribed prior to deposition of the semiconductor layers. The metal oxide layer provides a benefit to the photovoltaic devices when placed between the TCO and semiconductor layers. An additional benefit is an increased level of homogeneous film growth for subsequent depositions.

Electrically conducting particles can be added to the precursor solution, and upon spray deposition, those particles are embedded in the metal oxide coating. As a result the film exhibits a dramatically reduced electrical resistance. The metal oxide has a sheet resistance of about 100 mega ohms, but incorporating a metallic conductor such as TiC, carbon black, or Cu nanoparticles in the metal oxide layer lowers the sheet resistance (1 k to 20 k-ohm) of the layer. This can be used as a backside contact material between the semiconductor and the metal electrode. With a sheet resistant of 10 k to 20 k-ohm the back contact layer can eliminate the effects of uniformities on the semiconductor surface.

As an example, a CdS/CdTe device (2 inch by 2 inch) with a highly nonuniform surface phtovoltage (varying from 400 to 600 mV) coated with a layer of ZrO₂/TiC particles causes the surface phtovoltage to increase to a uniform value of 840 mV.

As a further example, a SnO₂:F/TiO₂/CdTe device (4 in by 4 in) with a poor surface photovoltage of circa 50 to 100 mV coated with a layer of ZrO₂/TiC results in a surface photovoltage increase to about 400 mV. Other photovoltaic absorber layers, such as CuS, CdSe, and the like, can also be used.

The invention may also be used to fabricate monolithic solid oxide fuel cells.

A solution of the ZrO₂ precursor can be added to solutions containing other metal cations, wherein the low temperature decomposition of the zirconium compound can enhance the decomposition rate of the other metal compound. For example a zirconium oxide precursor solution can be added to a solution of tin tetrachloride/ammonium fluoride dissolved in water, which produces superior SnO₂:F coatings. Likewise, a ZrO₂ precursor solution can be added to a TiO₂ precursor solution, to provide coatings containing a mixture of ZrO₂ and TiO₂, which provide the coating at a lower temperature.

A substrate may be provided with anti-reflective properties while maintaining a photocatalytic surface by depositing a layer of WO₃ onto a TiO₂ coated substrate. This provides a coating wherein a lower refractive index photocatalytic layer is placed over a higher refractive index TiO₂-based film. Similarly, a coating of higher refractive index than that of TiO₂ (such as for example Fe₂O₃ or PbO) is deposited such that it is placed between the substrate and photocatalytic TiO₂ layer. The net effect is the fabrication of a coating capable of imparting photocatalytic and anti-reflective properties to photovoltaic devices. This will result in a net increase in power obtained from the photovoltaic devices while also maintaining the surface of the device exposed to sunlight in a clean state. Having the photovoltaic device, or more importantly an array of photovoltaic devices, maintained in a homogeneous, clean state would increase their stable lifetimes.

Following are predictive examples of the inventive process, and the products made thereby.

To a solution of hydrochloride acid (20 mL, 12 M) is added 20 grams of a commercial solution of Zr(OR)₄ in the alcohol (HOR), where R=Me, Et, Pr, Bu or another organic radical, resulting in the formation of a thick slurry. Water is added to dissolve the white solid material and the solution loaded into a spray device. The solution is sprayed onto a heated substrate (200° C., glass), wherein a coating of ZrO₂ forms on the glass surface exhibiting a sheet resistance of circa 50-mega ohm.

The same procedure is employed at various temperatures (ranging from 150 degrees C. to 550 degrees C.) with the same results.

The same procedure is employed on a variety of substrates (such as low-E coated glass, CdTe, Si, and metals) with the same results.

The same procedure is employed wherein the pH of the solution is varied, with the same results.

The same procedure is employed with other metal compounds, such as for example titanium compound, aluminum compound, tin compound, iron compound, and silicon compound, with similar results for the fabrication of metal oxide coatings.

To a solution of the spray precursor is added 5 grams of commercial TiC particles. The slurry is sonicated for 1 minute, providing a suspension that does not settle after five minutes. The slurry is loaded into a sprayer and then sprayed onto a heated substrate (200° C., glass), resulting in a gray coating exhibiting a sheet resistance of circa 10-kilo ohm.

The same procedure is employed at various temperatures (ranging from 150 degrees C. to 500 degrees C.) with the same results.

The same procedure is employed on a variety of substrates (such as low-E coated glass, CdTe, Si, and metals) with the same results.

The same procedure is employed with various particles (such as carbon black, RuO₂, Pd in carbon, and metals) with similar results.

The same procedure is employed with various dopants (such as for example titanium, tungsten, nitrogen, sulfide, and fluoride) with enhanced properties given to the metal oxide coating.

A solution of H₂WO₄ is sprayed onto heated glass coated with a film of TiO₂, thereby depositing a film of WO₃ onto the TiO₂ surface. The coating provides photocatalytic activity and anti-reflective properties to the glass substrate; which when used as a cover plate for a photovoltaic device provides an enhanced photogenerated current (upon illumination with light) relative to the same measurement made with uncoated glass as the cover plate.

A solution of Fe₂O₃ precursor solution is sprayed onto heated glass, followed by the spraying of a TiO₂ precursor solution, thereby depositing a film of TiO₂ onto the surface of the Fe₂O₃ film. This coating provides photocatalytic activity and anti-reflective properties to the glass substrate; which when used as a cover plate for a photovoltaic device provides an enhanced photogenerated current (upon illumination with light) relative to the same measurement made with uncoated glass as the cover plate.

The invention is more easily comprehended by reference to the specific embodiments recited hereinabove, which are representative of the invention. It must be understood, however, that the specific embodiments are provided only for the purpose of illustration, and that the invention may be practiced otherwise than as specifically illustrated without departing from its spirit and scope.

What is claimed is:

1. In a liquid spray pyrolytic coating system for coating substrates, including a furnace, a spray chamber and an atomizer for directing a coating material on the surface of the substrate wherein the improvement comprises:
a positive displacement pump having an inlet communicating with a source of liquid coating material and an outlet communicating with the atomizer;
a DC motor for operating the pump; and
electric storage battery means for supplying electrical energy to the DC motor.

2. The invention defined in claim 1 wherein the electric storage battery means includes at least two sets of electric storage batteries.

3. The invention defined in claim 2 including a sensor for measuring the electrical discharge of the set of electric storage batteries providing power to the DC motor.

4. The invention defined in claim 3 wherein the sensor automatically selectively electrically couples one set of charged electric storage batteries to the DC motor when the one set is suitable charged.

5. The invention defined in claim 1 wherein the furnace and spray chamber include a conveyor for conveying a substrate to be coated by the atomizer.

6. The invention defined in claim 5 wherein the pressure of the spray chamber is maintained at atmosphere.

7. The invention defined in claim 6 wherein the atomizer produces a mist formed of droplets of the liquid coating material directed to the substrate.

8. The invention defined in claim 7 including means to electrostatically charge the droplets of coating material.

9. The invention defined in claim 1 including a plate disposed adjacent the substrate for electrostatically attracting the droplets of coating material.

10. A process for applying a metal oxide coating to a substrate, comprising the steps of:
providing a solution of a metal compound in a solvent;
spraying the solution onto the surface of a hot substrate; and
pyrolyzing the solution to form a coating of metal oxide on the substrate.

11. The process for applying a metal oxide coating to a substrate according to claim 10, wherein the metal compound comprises M(OR)₄, wherein M is at least one of titanium, zirconium, tungsten, and iron, and OR is at least one of methoxide, ethoxide, isopropoxide, n-propoxide, n-butoxide, acetylacetonate, nitrate, and oxolate.

12. The process for applying a metal oxide coating to a substrate according to claim 11, wherein the metal compound comprises at least one of titanium and zirconium tetramethoxide.

13. The process for applying a metal oxide coating to a substrate according to claim 10, wherein the solution solvent comprises at least one of water, an acid, and an alcohol.

14. The process for applying a metal oxide coating to a substrate according to claim 10, wherein the solution additionally contains a dopant comprising at least one of TiC, carbon black, RuO₂, Pd in carbon, ZnO, Ta₂O₅, MgO, CuO, Bi₂O₃, TeO₂, WO₃, TaC, GeO₂, MoO₃, Sb₂O₃, a nitride, a sulfide, a fluoride, and metal particles.

15. The process for applying a metal oxide coating to a substrate according to claim 14, wherein the dopant comprises TiC.

16. The process for applying a metal oxide coating to a substrate according to claim 10, wherein the substrate comprises at least one of glass, coated glass, a silicon single crystal wafer, a semiconductor device, fused quartz, plastic, and cloth.

17. The process for applying a metal oxide coating to a substrate according to claim 16, wherein the substrate comprises a semiconductor device.

18. The process for applying a metal oxide coating to a substrate according to claim 10, wherein the substrate is at a temperature from about 65 degrees C. to about 550 degrees C.

19. The process for applying a metal oxide coating to a substrate according to claim 18, wherein the temperature ranges from about 200 degrees C. to about 250 degrees C.

20. A metal oxide coated substrate prepared by the process of claim 10.
